(19) United States
(12) Patent Application Publication
(10) Pub. No.: US 2010/0045710 A1
(43) Pub. Date: Feb. 25, 2010

(54) BACKLIGHT APPARATUS AND A LIQUID CRYSTAL DISPLAY INCLUDING THE SAME

(76) Inventors: Ho-Sup CHOI, Seoul (KR); Sang-Youn KIM, Cheonan-si (KR); Byoung-Haw PARK, Cheonan-si (KR); Kyu-Min KWON, Asan-si (KR)

Correspondence Address: F. CHAU & ASSOCIATES, LLC, 130 WOODBURY ROAD, WOODBURY, NY, 11797, US

(21) Appl. No.: 12/545,197

(22) Filed: Aug. 21, 2009

(30) Foreign Application Priority Data
Aug. 22, 2008 (KR) 10-2008-0082405

(51) Int. Cl. G09G 5/10; G09G 3/36

(52) U.S. Cl. 345/690; 345/102

(57) ABSTRACT

A liquid crystal display includes a liquid crystal panel, a backlight unit, and a backlight control circuit. The liquid crystal panel displays an image. The backlight unit supplies light to the liquid crystal panel and includes a plurality of backlight blocks arranged in a matrix. The backlight control circuit controls the backlight unit. When the backlight control circuit turns on at least one of the backlight blocks, it turns off any remaining backlight blocks arranged in a same row of the backlight unit.

### CROSS-REFERENCE TO RELATED APPLICATION

This application claims priority to Korean Patent Application No. 2008-82405 filed on Aug. 22, 2008, the disclosure of which is incorporated by reference herein in its entirety.

### BACKGROUND

1. Technical Field

The present invention relates to a backlight apparatus and a liquid crystal display including the same.

2. Discussion of the Related Art

Display apparatuses used for computer monitors, televisions (TVs), and mobile devices may include a cathode ray tube (CRT), a field emission device (FED), and a liquid crystal display (LCD). Of these, the LCD is a non-emissive device that requires a light source.

The LCD includes a backlight unit (BLU), a driving circuit unit, and a liquid crystal panel. The BLU supplies light to the liquid crystal panel. The driving circuit unit drives the liquid crystal panel. The liquid crystal panel includes liquid crystal cells arranged in the form of a matrix. Light transmittance of each liquid crystal cell varies according to a voltage charged in the liquid crystal cell. The LCD adjusts the light transmittance of each liquid crystal cell through the driving circuit unit, and displays an image by supplying light from the BLU to the liquid crystal cells.

The BLU may employ a cold cathode fluorescent lamp (CCFL), an external electrode fluorescent lamp (EEFL), a flat fluorescent lamp (FFL), or a light emitting diode (LED). An LED-based BLU can achieve high color reproducibility, a high dynamic contrast ratio, and can reduce motion blur.

An image is scanned in an upper portion of the liquid crystal panel in a row. The BLU operates in response to a pulse width modulation signal to adjust a brightness of the image. For example, the BLU is turned on/off during a duty cycle of the pulse width modulation signal. Since the image is scanned in the upper portion of the liquid crystal panel prior to scanning it in a lower portion of the liquid crystal panel, the image scanned at the upper portion of the liquid crystal panel receives a greater amount of light from the BLU than the image scanned at the lower portion of the liquid crystal panel. Accordingly, there may be a brightness difference between the upper and lower portions of the liquid crystal panel.

Since the BLU is turned on/off in response to a pulse width modulation signal, liquid crystal cells are charged when the BLU is turned off. If light is supplied to these liquid crystal cells from the BLU, a capacitance thereof is changed, causing them to leak current. Thus, the light transmittance of the liquid crystal cells that are charged when the BLU is turned on is different from the light transmittance of the liquid crystal cells that are charged when the BLU is turned off. The different light transmittances may cause a brightness difference in an image displayed on the liquid crystal panel. Since the liquid crystal cells are charged in a row, the brightness difference may occur between rows.

The above-described brightness differences can cause a waterfall on the liquid crystal panel. Accordingly, there is a need to reduce/prevent the waterfall from occurring.

### SUMMARY

In an exemplary embodiment of the present invention, a liquid crystal display includes a liquid crystal panel, a backlight unit, and a backlight control circuit. The liquid crystal panel displays an image. The backlight unit supplies light to the liquid crystal panel and includes a plurality of backlight blocks arranged in a matrix. The backlight control circuit controls the backlight unit. The backlight control circuit turns on at least one of the backlight blocks and turns off any remaining backlight blocks arranged in a same row of the backlight unit.

The backlight blocks arranged in the same row of the backlight unit are alternately turned on and off in a row direction.

The backlight blocks arranged in a same column of the backlight unit are alternately turned on and off in a column direction.

A pulse width modulation signal is applied to the backlight blocks of the backlight unit to adjust a brightness of the image.

Each of the backlight blocks includes a plurality of light emitting diodes.

The backlight control circuit individually controls the backlight blocks.

The liquid crystal panel scans an image signal in a column direction in a row. The backlight blocks arranged in first and second rows of the backlight unit are alternately turned on and off in row and column directions when the image signal is scanned in a first row of the liquid crystal panel. The backlight blocks arranged in the first and second rows of the backlight unit are turned on when the image signal is scanned in a second row of the liquid crystal panel.

The backlight control circuit applies a pulse width modulation signal corresponding to brightness information of the image signal scanned in the first row of the liquid crystal panel to the backlight blocks arranged in the first and second rows of the backlight unit when the image signal is scanned in the first row of the liquid crystal panel.

The backlight blocks arranged in third and fourth rows of the backlight unit are alternately turned on and off in row and column directions when the image signal is scanned in a third row of the liquid crystal panel.

The backlight blocks of the backlight unit are alternately turned on and off in row and column directions when the image signal is scanned in a first row of the liquid crystal panel. An on-off state of the backlight blocks of the backlight unit is inverted when the image signal is scanned in a second row of the liquid crystal panel as compared to when the image signal is scanned in the first row of the liquid crystal panel. The on-off state of the backlight blocks of the backlight unit is inverted when the image signal is scanned in a third row of the liquid crystal panel as compared to when the image signal is scanned in the second row of the liquid crystal panel.

The backlight control circuit applies a pulse width modulation signal corresponding to brightness information of the image signal scanned in the first row of the liquid crystal panel to the backlight blocks of the backlight unit when the image signal is scanned in the first row of the liquid crystal panel.

The backlight unit includes a plurality of printed circuit boards arranged in a column direction, and the backlight blocks are formed on the printed circuit boards. The backlight control circuit includes a plurality of controllers to control the printed circuit boards, respectively.

In an exemplary embodiment of the present invention, a backlight apparatus includes a backlight unit and a backlight control circuit. The backlight unit includes a plurality of backlight blocks arranged in a matrix. The backlight control circuit controls the backlight unit. The backlight control circuit turns on at least one of the backlight blocks and turns off any remaining backlight blocks arranged in a same row of the backlight unit.

The backlight blocks are alternately turned on and off in row and column directions.

A pulse width modulation signal is applied to the backlight blocks to adjust a brightness of the backlight unit.

### BRIEF DESCRIPTION OF THE DRAWINGS

The above and other features of the present invention will become more apparent by describing in detail exemplary embodiments thereof with reference to the accompanying drawings in which:

FIG. 1 is a block diagram of a liquid crystal display according to an exemplary embodiment of the present invention;

FIG. 2 is a view of a backlight apparatus of FIG. 1 according to an exemplary embodiment of the present invention;

FIGS. 3 to 6 are views of a backlight unit of the backlight apparatus of FIG. 2, which are used to illustrate a local dimming operation according to an exemplary embodiment of the present invention; and

FIGS. 7 to 10 are views of the backlight unit of the backlight apparatus of FIG. 2, which are used to illustrate a local dimming operation according to an exemplary embodiment of the present invention.

### DETAILED DESCRIPTION OF EXEMPLARY EMBODIMENTS

Exemplary embodiments of the present invention provide a backlight apparatus and a liquid crystal display (LCD) including the same that are capable of controlling a local dimming operation to reduce/prevent a waterfall. In addition, the backlight apparatus and the LCD including the same can perform an impulsive operation.

Hereinafter, the exemplary embodiments of the present invention will be described more fully with reference to the accompanying drawings.

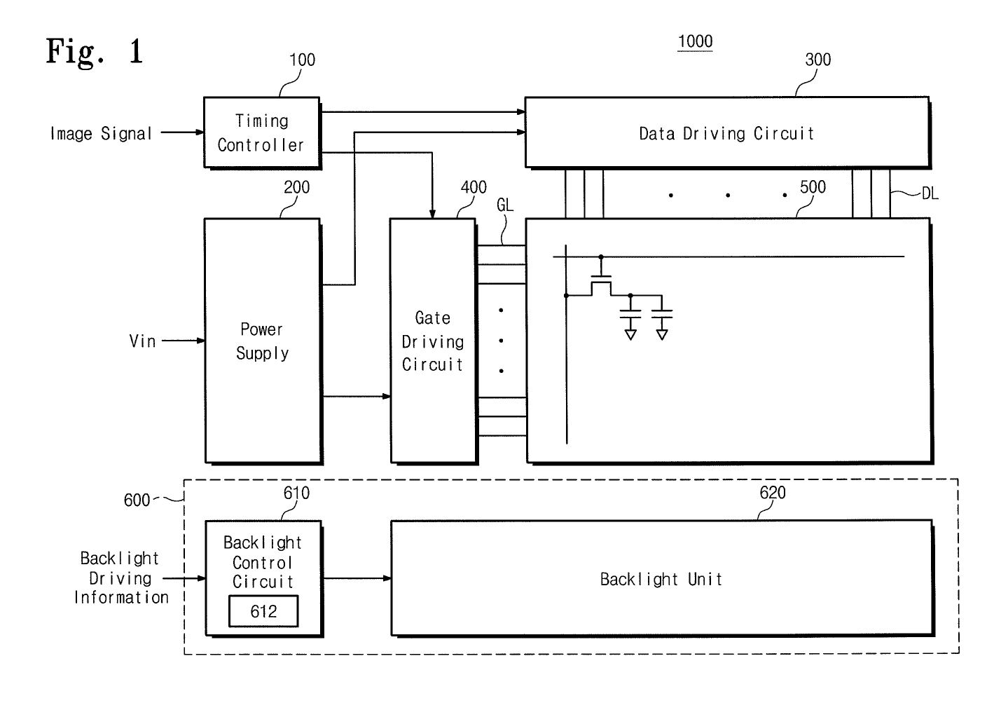

FIG. 1 is a block diagram of an LCD according to an exemplary embodiment of the present invention.

Referring to FIG. 1, an LCD 1000 includes a timing controller 100, a power supply 200, a data driving circuit 300, a gate driving circuit 400, a liquid crystal panel 500, and a backlight apparatus 600.

The timing controller 100 controls the data driving circuit 300 and the gate driving circuit 400 in response to an image signal transmitted from an exterior. For example, the timing controller 100 may receive digital image signals (red (R), green (G), and blue (B)) from the exterior. The timing controller 100 generates a gate control signal in response to the digital image signals (R, G, and B) transmitted from the exterior. The gate control signal may be transmitted to the gate driving circuit 400. The timing controller 100 may generate a control signal for the digital image signals (R, G, and B) and a data control signal in response to the digital image signals (R, G, and B) transmitted from the exterior. The control signal for the digital image signals (R, G, and B) and the data control signal may be transmitted to the data driving circuit 300.

The power supply 200 supplies a driving power to the data driving circuit 300 and the gate driving circuit 400. For example, the power supply 200 receives an input voltage Vin from an exterior to generate a driving voltage VDD, a gate-on voltage Von, a gate-off voltage Voff, and a gamma voltage. The gamma voltage may be transmitted to the data driving circuit 300. The gate-on voltage Von and the gate-off voltage Voff are transmitted to the gate driving circuit 400. The driving voltage VDD may be used as the driving power for the components of the LCD 1000. Although not shown in FIG. 1, the power supply 200 may additionally generate a common voltage Vcom. The common voltage Vcom may be transmitted to the liquid crystal panel 500.

The data driving circuit 300 receives power from the power supply 200 to operate under the control of the timing controller 100. The data driving circuit 300 generates analog gray-scale voltages corresponding to the digital image signals (R, G, and B), which are transmitted from the timing controller 100, by using the gamma voltage transmitted from the power supply 200. The data driving circuit 300 applies the analog gray-scale voltages to data lines DL whenever the gate-on voltage Von is applied to gate lines GL of the liquid crystal panel 500.

The gate driving circuit 400 receives power from the power supply 200 to operate under the control of the timing controller 100. The gate driving circuit 400 receives the gate-on voltage Von and the gate-off voltage Voff from the power supply 200. The gate driving circuit 400 sequentially applies the gate-on voltage Von and the gate-off voltage Voff to the gate lines GL of the liquid crystal panel 500 under the control of the timing controller 100.

The liquid crystal panel 500 is connected to the data driving circuit 300 through the data lines DL, and is connected to the gate driving circuit 400 through the gate lines GL. The liquid crystal panel 500 includes a plurality of liquid crystal cells connected to the data lines DL and the gate lines GL. For brevity, FIG. 1 shows one data line DL, one gate line GL, and one liquid crystal cell. The liquid crystal panel 500 includes a plurality of liquid crystal cells arranged in the form of a matrix. If the gate-on voltage Von is applied to the gate line GL, a transistor of the liquid crystal cell is turned on. If the analog gray-scale voltage is applied to the data line DL, the analog gray-scale voltage is charged in a capacitor of the liquid crystal cell. If the gate-off voltage Voff is applied to the gate line GL, the transistor of the liquid crystal cell is turned off. The liquid crystal cell drives liquid crystal according to the charged voltage to adjust light transmittance of the liquid crystal.

The backlight apparatus 600 supplies light to the liquid crystal panel 500 in response to backlight driving information transmitted from an exterior. For example, the backlight driving information may include brightness information of an image. The backlight apparatus 600 includes a backlight control circuit 610 and a backlight unit 620.

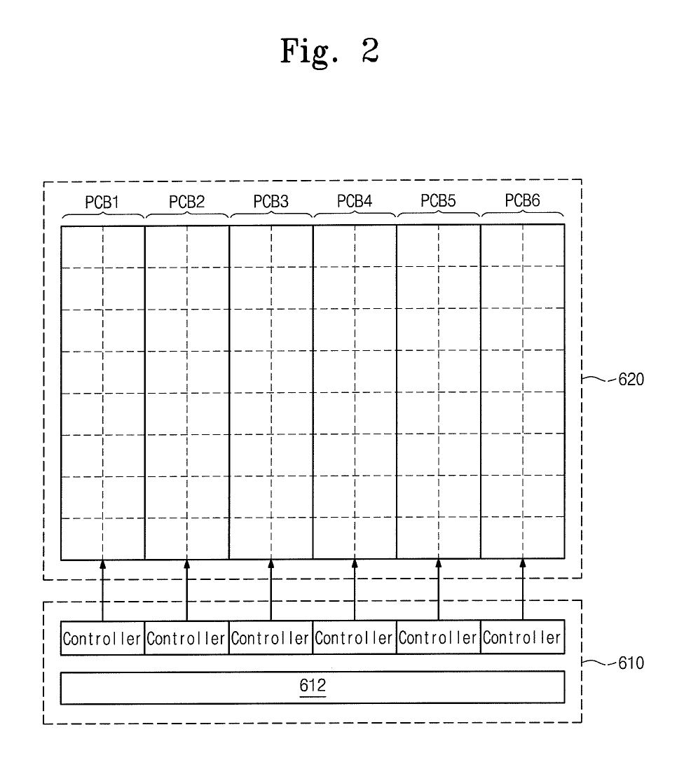

The backlight control circuit 610 adjusts a brightness of the backlight unit 620 in response to the backlight driving information transmitted from an exterior. For example, the backlight control circuit 610 may adjust the brightness of the backlight unit 620 by controlling a pulse width of a pulse width modulation signal applied to the backlight unit 620. The backlight control circuit 610 may include a storage circuit 612. The storage circuit 612 may store brightness information used to control the backlight unit 620. The backlight unit 620 includes a plurality of backlight blocks turned on or off under the control of the backlight control circuit 610. The backlight blocks are arranged in the form of a matrix. Hereinafter, the backlight apparatus 600 will be described in more detail with reference to FIG. 2.

To adjust the brightness of an image, the backlight apparatus 600 performs a dimming operation. The dimming operation is performed by applying a pulse width modulation signal to the backlight unit 620. For example, if the pulse width modulation signal is at a high level, backlight blocks of the backlight unit 620 may supply light. If the pulse width modulation signal is at a low level, the backlight blocks of the backlight unit 620 may not supply light. The pulse width modulation signal has low and high levels in a duty cycle. If a duration of a high level of the pulse width modulation signal is longer than a duration of a previous level of the pulse width modulation signal, in other words, if a pulse width at the high level of the pulse width modulation signal is wider than a pulse width at the previous level of the pulse width modulation signal, a light supply time of the backlight blocks of the backlight unit 620 may be lengthened. In other words, a brightness of the backlight blocks may be increased.

A local dimming operation is performed in a unit of the backlight blocks to adjust the brightness of the image. The backlight apparatus 600 and the LCD 1000 including the backlight apparatus 600 control the local dimming operation to reduce/prevent a waterfall and to perform an impulsive operation.

FIG. 2 is a view of the backlight apparatus 600 of FIG. 1 according to an exemplary embodiment of the present invention.

Referring to FIG. 2, the backlight apparatus 600 includes the backlight control circuit 610 and the backlight unit 620. The backlight unit 620 includes a plurality of printed circuit boards PCB1 to PCB6 arranged in a column direction. For example, as shown in FIG. 2, the backlight unit 620 may include six printed circuit boards PCB1 to PCB6.

Each of the six printed circuit boards PCB1 to PCB6 includes a plurality of backlight blocks. For example, as shown in FIG. 2, each of the six printed circuit boards PCB1 to PCB6 includes 16 backlight blocks. The backlight blocks are arranged in the form of a matrix. Each backlight block serves as a unit to perform a local dimming operation. For example, the backlight blocks may be individually turned on/off, and pulse width modulation signals may be individually applied to the backlight blocks to adjust the brightness of an image. For example, the backlight unit 620 may include a light emitting diode (LED). In other words, each of the backlight blocks includes at least one LED.

The backlight control circuit 610 includes a plurality of controllers and the storage circuit 612. The controllers correspond to the six printed circuit boards PCB1 to PCB6 of the backlight unit 620, respectively. In other words, one controller controls backlight blocks of one printed circuit board. The controllers individually control backlight blocks provided in the respective printed circuit boards PCB1 to PCB6. For example, each controller includes two control circuits having eight channels, respectively. The controller turns on/off the backlight blocks. The controller applies a pulse width modulation signal corresponding to brightness information to a backlight block to adjust a brightness of the backlight block. The storage circuit 612 may store brightness information of the backlight unit 620.

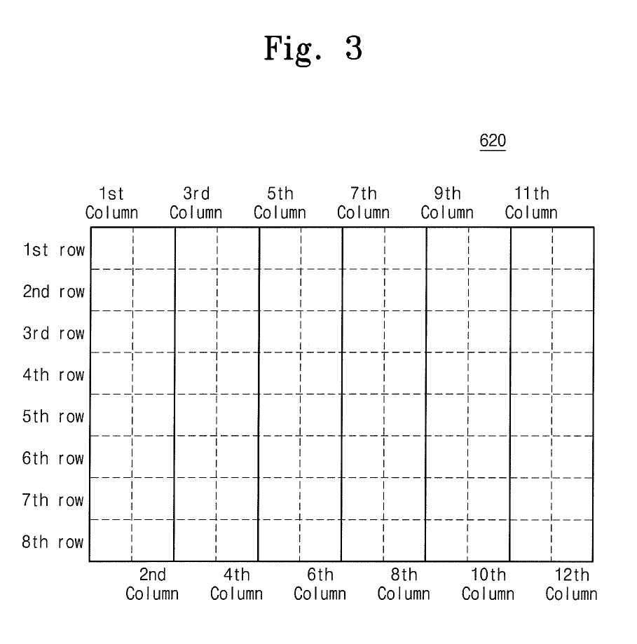

FIGS. 3 to 6 are views used to illustrate a local dimming operation according to an exemplary embodiment of the present invention.

FIGS. 3 to 6 show the backlight unit 620. Of the backlight blocks arranged in the form of a matrix, the backlight blocks marked with oblique lines are turned on, and the backlight blocks having no oblique lines are turned off.

When an image is displayed on the liquid crystal panel 500 (see FIG. 1), the image is scanned in the column direction in a row. For example, when the liquid crystal panel 500 is driven with a frequency of 120 Hz, one frame of the image is displayed on the liquid crystal panel 500 by performing a scanning operation eight times.

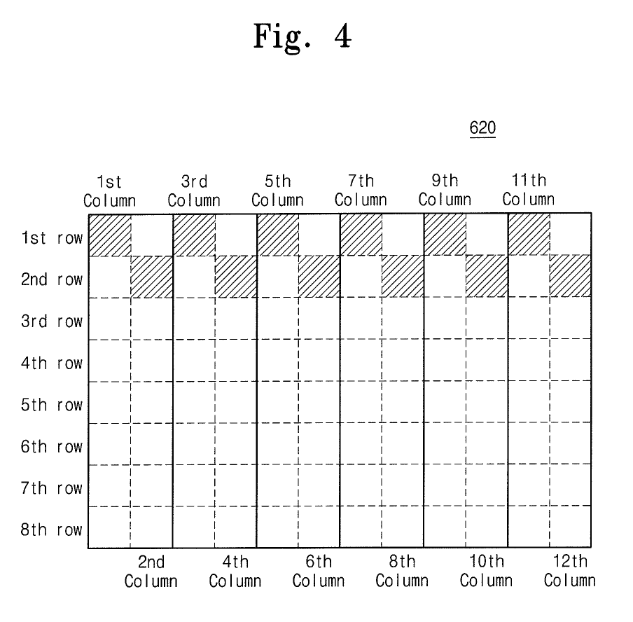

Referring to FIG. 3, before frames are transmitted, all backlight blocks of the backlight unit 620 are turned off. Referring to FIG. 4, when a scanning operation is first performed with respect to the liquid crystal panel 500, in other words, when a ⅛ frame is displayed on the liquid crystal panel 500, the backlight control circuit 610 (see FIG. 2) turns on some backlight blocks and turns off remaining backlight blocks arranged in first and second rows of the backlight unit 620. The backlight blocks provided in the first and second rows of the backlight unit 620 are alternately turned on and off in the row and column directions. In this case, brightness information corresponding to the first and second rows of the backlight unit 620 has been stored in the storage circuit 612. Pulse width modulation signals corresponding to the stored brightness information are applied to the backlight blocks provided in the first and second rows of the backlight unit 620.

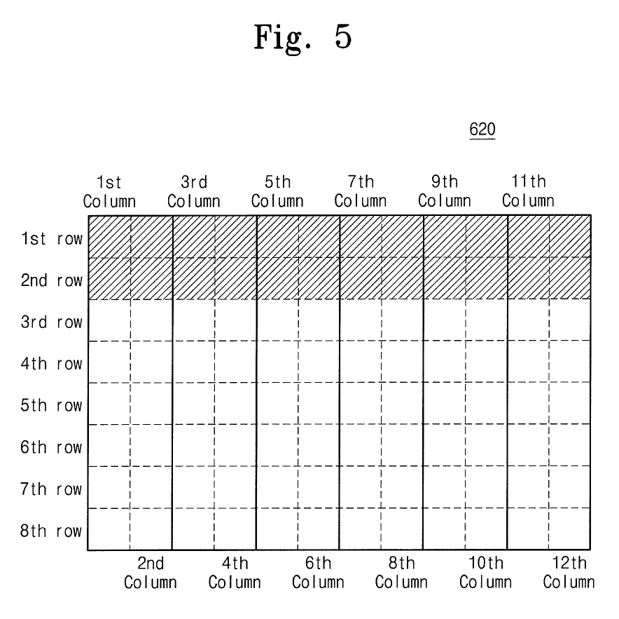

Referring to FIG. 5, when a scanning operation is second performed with respect to the liquid crystal panel 500, in other words, when a 2/8 frame is displayed on the liquid crystal panel 500, the backlight control circuit 610 turns on the backlight blocks provided in the first and second rows of the backlight unit 620. In this case, brightness information corresponding to the backlight blocks provided in third and fourth rows may be stored in the storage circuit 612.

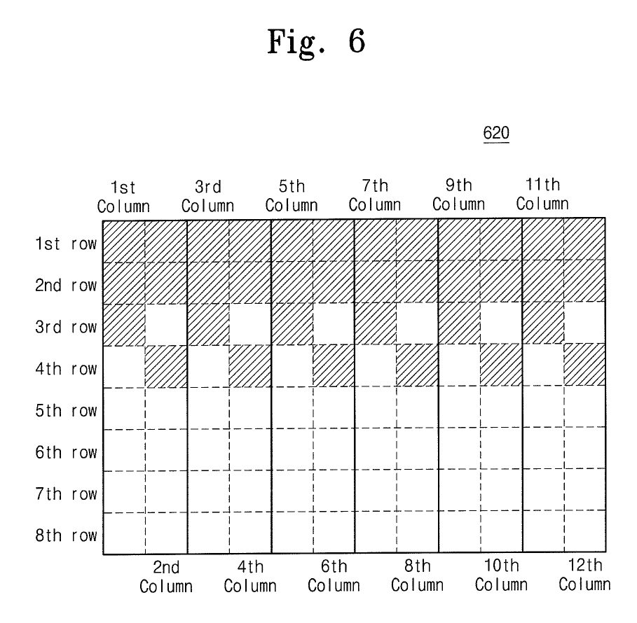

Referring to FIG. 6, when a scanning operation is third performed with respect to the liquid crystal panel 500, in other words, when a ⅜ frame is displayed on the liquid crystal panel 500, the backlight control circuit 610 turns on some backlight blocks and turns off remaining backlight blocks arranged in the third and fourth rows of the backlight unit 620. The backlight blocks provided in the third and fourth rows of the backlight unit 620 are alternately turned on and off in the row and column directions. In this case, brightness information corresponding to the third and fourth rows of the backlight unit 620 has been stored in the storage circuit 612. Pulse width modulation signals corresponding to the stored brightness information are applied to the backlight blocks provided in the first to fourth rows.

The following operations are performed similarly to those shown in FIGS. 4 and 6. When a scanning operation is fourth performed with respect to the liquid crystal panel 500, in other words, when a 4/8 frame is displayed on the liquid crystal panel 500, the backlight blocks provided in the third and fourth rows of the backlight unit 620 are turned on. When a scanning operation is fifth performed with respect to the liquid crystal panel 500, in other words, when a ⅝ frame is displayed on the liquid crystal panel 500, the backlight blocks provided in fifth and sixth rows of the backlight unit 620 are alternately turned on in the row and column directions. When a scanning operation is sixth performed with respect to the liquid crystal panel 500, in other words, when a 6/8 frame is displayed on the liquid crystal panel 500, the backlight blocks provided in the fifth and sixth rows of the backlight unit 620 are turned on. When a scanning operation is seventh performed with respect to the liquid crystal panel 500, in other words, when a ⅞ frame is displayed on the liquid crystal panel 500, the backlight blocks provided in seventh and eighth rows of the backlight unit 620 are alternately turned on in the row and column directions. When a scanning operation is eighth performed with respect to the liquid crystal panel 500, in other words, when a 8/8 frame is displayed on the liquid crystal panel 500, the backlight blocks provided in the seventh and eighth rows of the backlight unit 620 are turned on.

As described above, according to the present exemplary embodiment, when an image is scanned on the liquid crystal panel 500, a boundary between the backlight blocks of the backlight unit 620 in the turn-on state and the backlight blocks of the backlight unit 620 in the turn-off state is attenuated. Thus, a waterfall can be prevented/reduced.

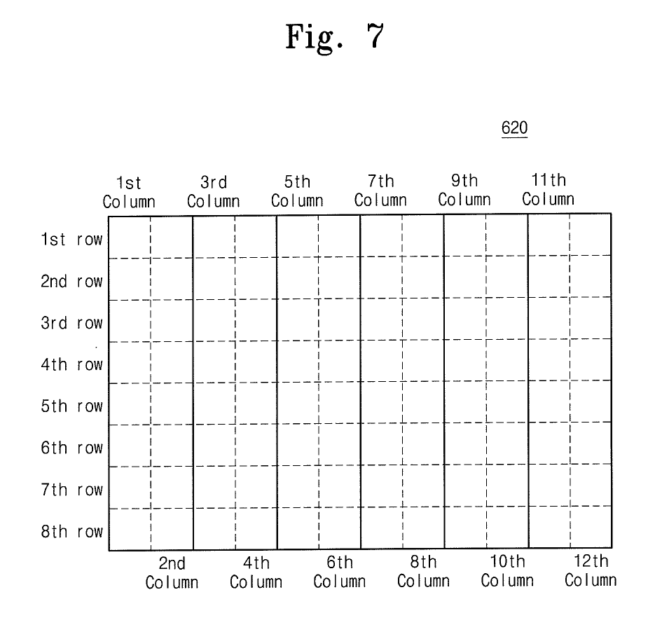

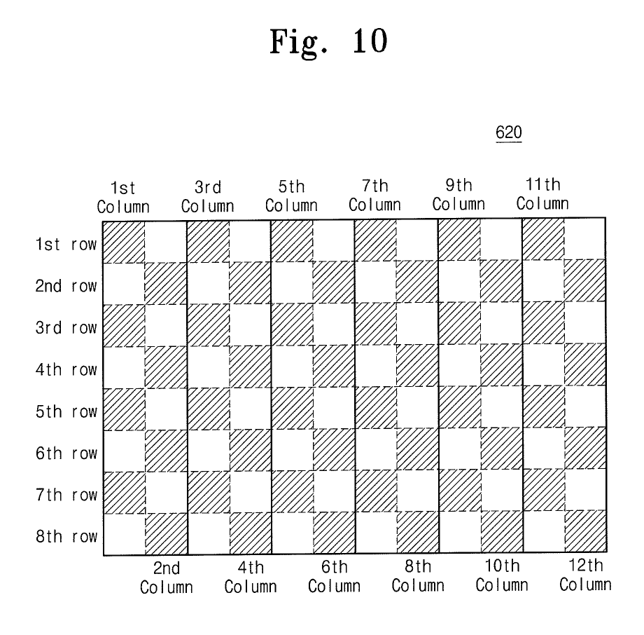

FIGS. 7 and 10 are views used to illustrate a local dimming operation according to an exemplary embodiment of the present invention.

FIGS. 7 to 10 show the backlight unit 620. Of the backlight blocks arranged in the form of a matrix, the backlight blocks marked with oblique lines are turned on, and the backlight blocks having no oblique lines are turned off.

When an image is displayed on the liquid crystal panel 500 (see FIG. 1), the image is scanned in a column direction in a row. For example, when the liquid crystal panel 500 is driven with a frequency of 120 Hz, one frame of the image is displayed on the liquid crystal panel 500 by performing a scanning operation eight times.

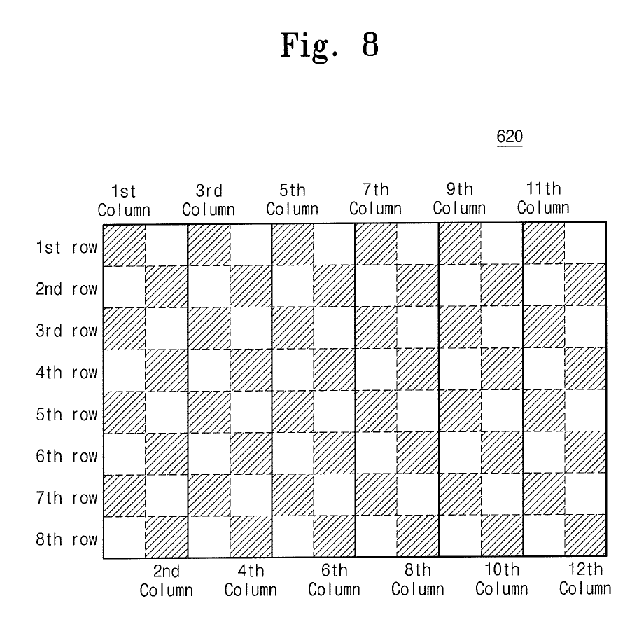

Referring to FIG. 7, before frames are transmitted, all backlight blocks of the backlight unit 620 are turned off. Referring to FIG. 8, when a scanning operation is first performed with respect to the liquid crystal panel 500, in other words, when a ⅛ frame is displayed on the liquid crystal panel 500, the backlight control circuit 610 (see FIG. 2) alternately turns on/off the backlight blocks of the backlight unit 620 in row and column directions. In this case, brightness information of the backlight unit 620 has been stored in the storage circuit 612. Pulse width modulation signals corresponding to the brightness information that has been stored in the storage circuit 612 are applied to the backlight blocks, respectively.

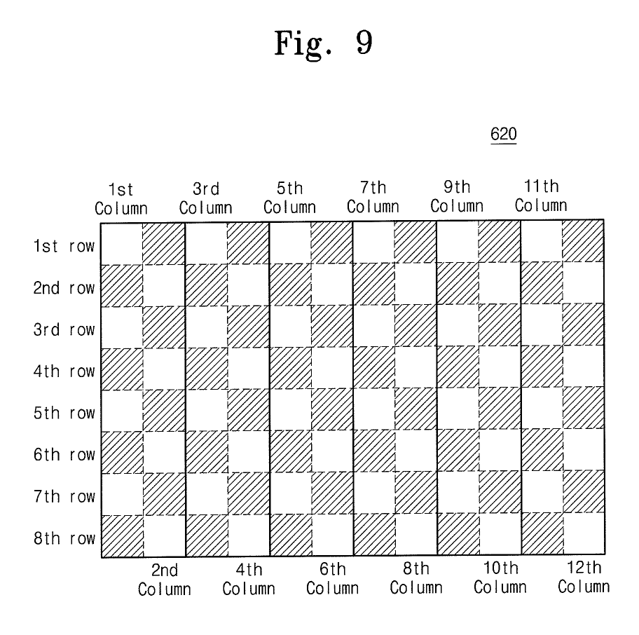

Referring to FIG. 9, when a scanning operation is second performed with respect to the liquid crystal panel 500, in other words, when a 2/8 frame is displayed on the liquid crystal panel 500, the backlight control circuit 610 inverts a state of the backlight blocks of the backlight unit 620 into a previous state. In other words, backlight blocks, which were turned on when the ⅛ frame was scanned on the liquid crystal panel 500, are turned off, and backlight blocks, which were turned off when the ⅛ frame was scanned on the liquid crystal panel 500, are turned on.

Referring to FIG. 10, when a scanning operation is third performed with respect to the liquid crystal panel 500, in other words, when a ⅜ frame is displayed on the liquid crystal panel 500, the backlight control circuit 610 inverts a state of the backlight blocks of the backlight unit 620 into a previous state. In other words, backlight blocks, which were turned on when the 2/8 frame was scanned on the liquid crystal panel 500, are turned off, and backlight blocks, which were turned off when the 2/8 frame was scanned on the liquid crystal panel 500, are turned on.

The following operations are performed similarly to those shown in FIGS. 7 and 10. When a scanning operation is fourth performed with respect to the liquid crystal panel 500, in other words, when a 4/8 frame is displayed on the liquid crystal panel 500, a state of the backlight blocks of the backlight unit 620 is inverted into a previous state. When a scanning operation is fifth performed with respect to the liquid crystal panel 500, in other words, when a ⅝ frame is displayed on the liquid crystal panel 500, a state of the backlight blocks of the backlight unit 620 is inverted into a previous state. When a scanning operation is sixth performed with respect to the liquid crystal panel 500, in other words, when a 6/8 frame is displayed on the liquid crystal panel 500, a state of the backlight blocks of the backlight unit 620 is inverted into a previous state. When a scanning operation is seventh performed with respect to the liquid crystal panel 500, in other words, when a ⅞ frame is displayed on the liquid crystal panel 500, a state of the backlight blocks of the backlight unit 620 is inverted into a previous state. When a scanning operation is eighth performed with respect to the liquid crystal panel 500, in other words, when a 8/8 frame is displayed on the liquid crystal panel 500, a state of the backlight blocks of the backlight unit 620 is inverted into a previous state.

When the backlight control circuit 610 applies a pulse modulation signal to the backlight unit 620 corresponding to brightness information that has been stored in the storage circuit 612, brightness information of a next frame is stored in the storage circuit 612.

As described above, according to the present exemplary embodiment, a boundary between the backlight blocks of the backlight unit 620 in a turn-on state and the backlight blocks of the backlight unit 620 in a turn-off state is attenuated. Thus, a waterfall can be reduced/prevented. In addition, when image signals are scanned on the liquid crystal panel 500, a state of the backlight blocks of the backlight unit 620 is inverted. Accordingly, in the present exemplary embodiment, the backlight blocks perform an impulsive operation. Therefore, motion blur may be reduced/prevented.

Although the above-described backlight unit 620 employs light emitting diodes, it is not limited thereto. For example, the backlight blocks thereof may include a cold cathode fluorescent lamp (CCFL), an external electrode fluorescent lamp (EEFL), or a flat fluorescent lamp (FFL).Although the exemplary embodiments of the present invention have been described, it is understood that the present invention should not be limited to these exemplary embodiments but various changes and modifications can be made by one of ordinary skill in the art within the spirit and scope of the present invention as hereinafter claimed.

What is claimed is:

1. A liquid crystal display, comprising:
a liquid crystal panel that displays an image;
a backlight unit that supplies light to the liquid crystal panel,
wherein the backlight unit comprises a plurality of backlight blocks arranged in a matrix; and
a backlight control circuit that controls the backlight unit,
wherein the backlight control circuit turns on at least one of the backlight blocks and turns off any remaining backlight blocks arranged in a same row of the backlight unit.

2. The liquid crystal display of claim 1, wherein the backlight blocks arranged in the same row of the backlight unit are alternately turned on and off in a row direction.

3. The liquid crystal display of claim 1, wherein the backlight blocks arranged in a same column of the backlight unit are alternately turned on and off in a column direction.

4. The liquid crystal display of claim 1, wherein a pulse width modulation signal is applied to the backlight blocks of the backlight unit to adjust a brightness of the image.

5. The liquid crystal display of claim 1, wherein each of the backlight blocks comprises a plurality of light emitting diodes.

6. The liquid crystal display of claim 1, wherein the backlight control circuit individually controls the backlight blocks.

7. The liquid crystal display of claim 1, wherein the liquid crystal panel scans an image signal in a column direction in a row.

8. The liquid crystal display of claim 7, wherein the backlight blocks arranged in first and second rows of the backlight unit are alternately turned on and off in row and column directions when the image signal is scanned in a first row of the liquid crystal panel.

9. The liquid crystal display of claim 8, wherein the backlight blocks arranged in the first and second rows of the backlight unit are turned on when the image signal is scanned in a second row of the liquid crystal panel.

10. The liquid crystal display of claim 8, wherein the backlight control circuit applies a pulse width modulation signal corresponding to brightness information of the image signal scanned in the first row and a second row of the liquid crystal panel to the backlight blocks provided in the first and second rows of the backlight unit when the image signal is scanned in the first row of the liquid crystal panel.

11. The liquid crystal display of claim 7, wherein the backlight blocks arranged in third and fourth rows of the backlight unit are alternately turned on and off in row and column directions when the image signal is scanned in a third row of the liquid crystal panel.

12. The liquid crystal display of claim 7, wherein the backlight blocks of the backlight unit are alternately turned on and off in row and column directions when the image signal is scanned in a first row of the liquid crystal panel.

13. The liquid crystal display of claim 12, wherein an on-off state of the backlight blocks of the backlight unit is inverted when the image signal is scanned in a second row of the liquid crystal panel as compared to when the image signal is scanned in the first row of the liquid crystal panel.

14. The liquid crystal display of claim 13, wherein the on-off state of the backlight blocks of the backlight unit is inverted when the image signal is scanned in a third row of the liquid crystal panel as compared to when the image signal is scanned in the second row of the liquid crystal panel.

15. The liquid crystal display of claim 12, wherein the backlight control circuit applies a pulse width modulation signal corresponding to brightness information of the image signal scanned in the first row of the liquid crystal panel to the backlight blocks of the backlight unit when the image signal is scanned in the first row of the liquid crystal panel.

16. The liquid crystal display of claim 1, wherein the backlight unit comprises a plurality of printed circuit boards arranged in a column direction, and the backlight blocks are formed on the printed circuit boards.

17. The liquid crystal display of claim 16, wherein the backlight control circuit comprises a plurality of controllers to control the printed circuit boards, respectively.

18. A backlight apparatus, comprising:
a backlight unit that comprises a plurality of backlight blocks arranged in a matrix; and
a backlight control circuit that controls the backlight unit,
wherein the backlight control circuit turns on at least one of the backlight blocks and turns off any remaining backlight blocks arranged in a same row of the backlight unit.

19. The backlight apparatus of claim 18, wherein the backlight blocks are alternately turned on and off in row and column directions.

20. The backlight apparatus of claim 18, wherein a pulse width modulation signal is applied to the backlight blocks to adjust a brightness of the backlight unit.
